(19) United States
(12) Patent Application Publication
(10) Pub. No.: US 2024/0097475 A1
(43) Pub. Date: Mar. 21, 2024

(54) Battery Management Apparatus and Battery System

(71) Applicant: LG Energy Solution, Ltd., Seoul (KR)

(72) Inventors: Duk You Kim, Daejeon (KR); Seok Hyeong Ham, Daejeon (KR)

(73) Assignee: LG Energy Solution, Ltd., Seoul (KR)

(21) Appl. No.: 18/039,596

(22) PCT Filed: Jul. 11, 2022
(86) PCT No.: PCT/KR2022/010028

§ 371 Date: May 31, 2023

(30) Foreign Application Priority Data
Jul. 19, 2021 (KR) 10-2021-0094503

(51) Int. Cl. H02J 7/00; H02J 7/34

(52) U.S. Cl. CPC H02J 7/007182; H02J 7/0047; H02J 7/345; H02J 2207/50

(57) ABSTRACT

A battery management apparatus includes a switching unit configured to control electrical connection with a battery module and a controller configured to measure a voltage of a battery cell included in the battery module and to control a driving current transferred from the battery module by controlling on/off of the switching unit when the voltage of the battery cell is measured.

### CROSS-REFERENCE TO RELATED APPLICATIONS

The present application is a national phase entry under 35 U.S.C. § 371 of International Application No. PCT/KR2022/010028 filed Jul. 11, 2022, which claims priority from Korean Patent Application No. 10-2021-0094503 filed Jul. 19, 2021, all of which are incorporated herein by reference.

### TECHNICAL FIELD

Embodiments disclosed herein relate to a battery management apparatus and a battery system.

### BACKGROUND ART

A secondary battery is generally used as a battery pack including a battery module where a plurality of battery cells are connected to one another in series and/or in parallel. Battery packs may be managed and controlled by a battery management system (BMS) in terms of their states and operations.

With the increasing demand for such battery packs, the importance of the BMS for managing a battery is growing. To simply perform a function of measuring a voltage of each battery cell among various functions of the BMS, a monitoring integrated circuit (IC) is used. A voltage of each battery cell is input through a sensing line such that the monitoring IC may periodically measure the voltage of the battery cell.

In this case, a current for driving the monitoring IC is supplied from a battery module, and a big error occurs in measuring voltages of battery cells at opposite ends due to the current and an internal resistor of the battery module. Due to such an error, the voltages of the battery cells at the opposite ends of the battery module are measured lower than those of other battery cells, and a separate voltage measuring apparatus is required to correct the error.

### SUMMARY

### Technical Problem

Embodiments disclosed herein aim to provide a battery management apparatus and a battery system capable of increasing accuracy and improving reliability in measuring a voltage of a battery cell by temporally separating a sensing line and a driving current line, which are shared for a battery module, from each other.

Technical problems of the embodiments disclosed herein are not limited to the above-described technical problems, and other unmentioned technical problems would be clearly understood by one of ordinary skill in the art from the following description.

### Technical Solution

A battery management apparatus according to an embodiment disclosed herein includes a controller; and a switch configured to control electrical connection between a battery module and the controller, wherein the controller is configured to: measure a voltage of a battery cell included in the battery module; and control a driving current transferred from the battery module by controlling the switch based on the measured voltage.

According to an embodiment, when the switch is turned on, the battery module and the controller may be electrically connected to each other such that the driving current is transferred to the controller through an internal resistor of the battery module.

According to an embodiment, the controller may be further configured to turn off the switch during measurement of the voltage.

According to an embodiment, the battery module may include a plurality of battery cells and each battery cell may include a respective internal resistor provided at opposite ends of the battery cell.

According to an embodiment, the controller may be further configured to generate a control signal to turn off the switch during measurement of the voltage.

According to an embodiment, the switch may be contained within the controller.

According to an embodiment, the driving current may be transferred from the battery module to the controller.

According to an embodiment, the battery management apparatus may further include a power supply configured to supply a power supply driving current to the controller.

According to an embodiment, the power supply may be further configured to supply stored power to the controller while the switch is off.

According to an embodiment, the power supply may include at least one capacitor.

According to an embodiment, the capacitor of the power supply may be configured to be charged with power from the battery module while the switch is on.

A battery system according to an embodiment disclosed herein includes a battery module including a plurality of battery cells, an electricity storage unit connected to the battery module to store a corresponding voltage of each battery cell; a controller; and a switch positioned between the battery module and a controller and configured to control electrical connection between the battery module and the controller, wherein the controller is configured to: for each battery cell, measure a voltage of the battery cell based on the corresponding voltage stored in the electricity storage unit; and control a driving current transferred from the battery module by controlling the switch based on the measured voltage.

According to an embodiment, the electricity storage unit may include a plurality of capacitors, each capacitor corresponding to a respective battery cell.

According to an embodiment, while the switch is turned on, the battery module and the controller may be electrically connected to each other such that the driving current is transferred to the controller through an internal resistor of the battery module.

According to an embodiment, the controller may be further configured to turn off the switch during measurement of the voltage.

According to an embodiment, the battery system may further include a power supply connected to the controller and configured to supply a power supply driving current to the controller.

According to an embodiment, the power supply may be further configured to supply stored power to the controller while the switch is off.

According to an embodiment, the power supply may include at least one capacitor.

### Advantageous Effects

A battery management apparatus and a battery system according to an embodiment disclosed herein may increase accuracy and improve reliability in measuring a voltage of a battery cell by temporally separating a sensing line and a driving current line, which are shared for a battery module, from each other.

### BRIEF DESCRIPTION OF THE DRAWINGS

FIG. 1 is a block diagram showing configurations of a battery management apparatus and a battery system including the same, according to an embodiment disclosed herein.

FIG. 2 is a view of a conventional battery management apparatus.

FIG. 3 is a view of a battery management apparatus according to an embodiment disclosed herein.

FIG. 4 is a view of a battery management apparatus according to another embodiment disclosed herein.

FIG. 5 is a flowchart illustrating a control method of a battery management apparatus according to an embodiment disclosed herein.

FIG. 6 is a block diagram showing a hardware configuration of a computing system for performing a control method of a battery management apparatus, according to an embodiment disclosed herein.

### DETAILED DESCRIPTION

Hereinafter, various embodiments disclosed herein will be described in detail with reference to the accompanying drawings. In this document, identical reference numerals will be used for identical components in the drawings, and the identical components will not be redundantly described.

For various embodiments disclosed herein, specific structural or functional descriptions are only exemplified for the purpose of describing the embodiments, and various embodiments disclosed herein may be implemented in various forms, and should not be construed as being limited to the embodiments described herein.

As used in various embodiments, the terms “1st, “2nd”, “first”, “second”, or the like may modify various components regardless of importance, and do not limit the components. For example, a first component may be named as a second component without departing from the right scope of an embodiment disclosed herein, and similarly, the second component may be named as the first component.

Terms used in the present document are used for only describing a specific exemplary embodiment of the disclosure and may not have an intention to limit the scope of other exemplary embodiments of the disclosure. It is to be understood that the singular forms include plural references unless the context clearly dictates otherwise.

All terms including technical and scientific terms used herein have the same meaning as commonly understood by one of ordinary skill in the art to which the embodiments disclosed herein belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In some cases, the terms defined herein may be interpreted to exclude embodiments disclosed herein.

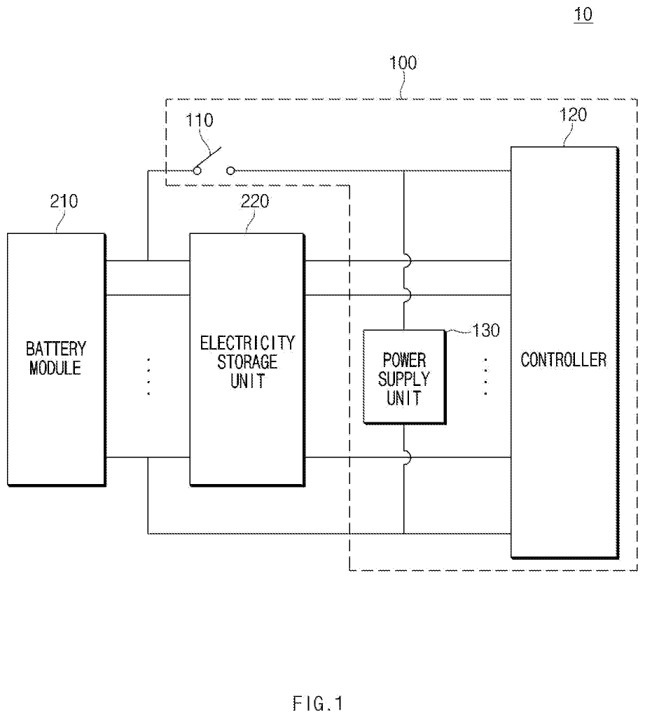

FIG. 1 is a block diagram showing configurations of a battery management apparatus and a battery system including the same, according to an embodiment disclosed herein.

Referring to FIG. 1, a battery system 10 according to an embodiment disclosed herein may include a battery management apparatus 100, a battery module 210, and an electricity storage unit 220. The battery management apparatus 100 according to an embodiment disclosed herein may include a switching unit 110, a controller 120, and a power supply unit 130.

The switching unit 110 may be provided to control a driving current applied from the battery module 210. Herein, the driving current may be a current for driving the controller 120. That is, the switching unit 110 may be provided between the battery module 210 and the controller 120 to control electrical connection between the battery module 210 and the controller 120. In this case, when the switching unit 110 is turned on, the battery module 210 and the controller 120 may be electrically connected to each other such that a driving current may be transferred to the controller 120 through an internal resistor of the battery module 210. Moreover, the switching unit 110 may include at least one switch, and may be provided at one end of the battery module 210. For example, the switching unit 110 may be provided outside or inside the controller 120.

The controller 120 may measure a voltage of each battery cell based on a voltage stored in the electricity storage unit 220. When a voltage of each battery cell is measured, the controller 120 may control the driving current transferred from the battery module 210 by controlling on/off of the switching unit 110. When the voltage of the battery cell is measured, the controller 120 may turn off the switching unit 110 such that the driving current does not flow from the battery module 210.

That is, when the voltage of the battery cell included in the battery module 210 is measured, the controller 120 may control the driving current by controlling on/off of the switching unit 110. When the voltage of the battery cell is measured, the controller 120 may turn off the switching unit 110 such that the driving current does not flow to the internal resistor of the battery module. For example, the internal resistor of the battery module 210 may be an internal resistor of battery cells provided at opposite ends among a plurality of battery cells included in the battery module 210.

When the voltage of the battery cell is measured, the controller 120 may generate a control signal for turning off the switching unit 110. The generated control signal may be transferred to the switching unit 110 to control an operation of the switching unit 110. For example, the controller 120 may include a monitoring integrated circuit (IC) provided in the battery management apparatus 50.

The power supply unit 130 may supply the driving current to the controller 120. For example, when the switching unit 110 is turned off by the controller 120, the power supply unit 130 may supply previously stored power to the controller 120. For instance, the power supply unit 130 may include a capacitor that may be charged by being supplied with power from the battery module 210 when the switching unit 110 is in an on state.

That is, when the switching unit 110 is in the on state, the power supply unit 130 may be charged with power being supplied from the battery module 210, and when the switching unit 110 is turned off, the power supply unit 130 may provide the driving current to the controller 120 based on the charged power.

The battery module 210 may include a plurality of battery cells. In this case, the battery module 210 may include the plurality of battery cells and an internal resistor.

The electricity storage unit 220 may be connected to the battery module 210 to store a voltage of each battery cell. For example, the electricity storage unit 220 may include a plurality of capacitors provided to correspond to respective battery cells. Thus, the controller 120 may detect a voltage of each battery cell by measuring a voltage stored in the electricity storage unit 220.

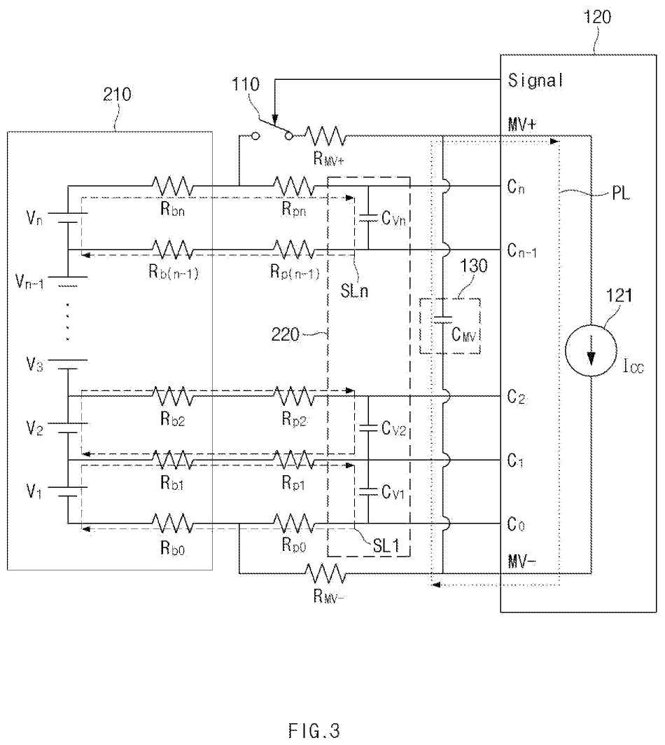

As such, the battery management apparatus 100 according to an embodiment disclosed herein may increase accuracy and improve reliability in measuring a voltage of a battery cell by temporally separating a sensing line and a driving current line (see FIG. 3), which are shared for a battery module, from each other. This will be described in more detail below.

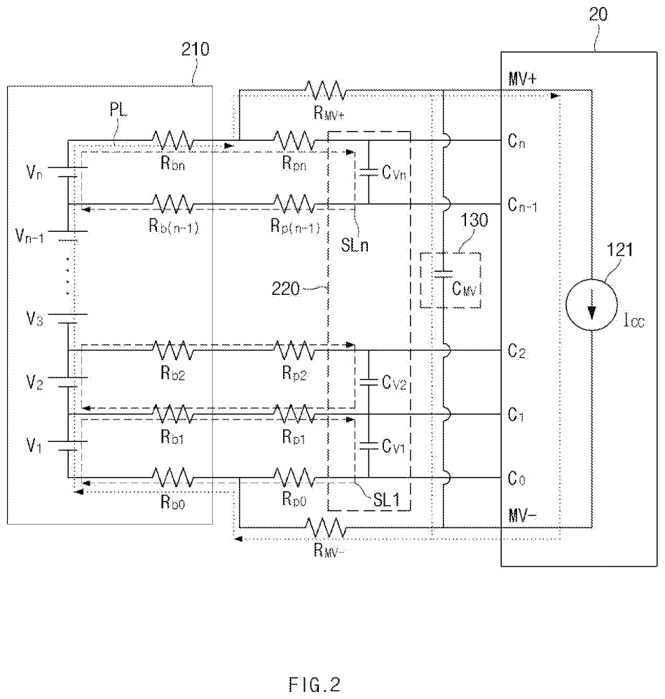

FIG. 2 is a view of a general battery management apparatus.

Referring to FIG. 2, for the general battery management apparatus, voltages V₁-Vₙ of respective battery cells may be applied to capacitors C_{V1}-C_{Vn} through sensing lines SL1-SLn. In this case, in a controller 120 (e.g., the monitoring IC), a voltage of a battery cell may be measured using voltages of the capacitors C_{V1}-C_{Vn}. R_{MV} of FIG. 2 may be a parasitic resistor of a driving current line PL, and R p may be a parasitic resistor of a sensing line SL.

Meanwhile, a driving current I_{CC} of the controller 20 may be supplied from the battery module 210 and may flow through a path of the driving current line PL. While it is shown in FIG. 2 that the driving current source I_{CC} 121 exists inside the controller 20, the driving current source I_{CC} 121 may be actually a current applied from the battery module 210.

While the sensing lines SL1-SLn may be separated from the driving current line PL outside the battery module 210 in the general battery management apparatus as shown in FIG. 2 (that is, Rₚₙ and R_{MV+}, Rₚ₀ and R_{MV-}), the sensing lines SL1-SLn may not be separated from the driving current line PL inside the battery module 210.

As such, the current of the sensing lines SL1-SLn and the driving current line PL flows in internal resistors R_{b0} and R_{bn} located at opposite ends of the battery module 210 in FIG. 2, and such a driving current has a high voltage value, resulting in voltage drops in R_{b0} and R_{bn}. Thus, a significantly smaller voltage than V₁ and Vₙ may be applied to C_{V1} and C_{Vn}, such that voltages of battery cells located at the opposite ends of the battery module 210 may be measured lower than those of other battery cells at all times.

FIG. 3 is a view of a battery management apparatus according to an embodiment disclosed herein.

Referring to FIG. 3, the battery management apparatus 100 according to an embodiment disclosed herein may generate a switch control signal when the controller 120 generates a voltage measurement command for a battery cell. Thus, the controller 120 may turn off the switching unit 110 to control the driving current not to flow to the internal resistors R_{b0} and R_{bn} of the battery module 210.

The capacitors C_{V1}-C_{Vn} of FIG. 3 have relatively small capacitances, and thus may be fixed to the voltages V₁-Vₙ of corresponding battery cells shortly after the switching unit 110 is turned off. The controller 120 may perform voltage measurement for each battery cell, and may accurately measure an actual voltage of a battery cell without an error caused by the internal resistors R_{b0} and R_{bn} of the battery cells.

Meanwhile, when the controller 120 measures a voltage of each battery cell (that is, the switching unit 110 is in an off state), the driving current of the controller 120 may be supplied from the power supply unit 130 C_{MV}. The power supply unit 130 C_{MV} may perform a function of preventing oscillation of a voltage of the battery module 210.

When the controller 120 has completed voltage measurement for a battery cell, the switching unit 110 may be turned on by a switch control signal of the controller 120 and the power supply unit 130 may start charging from the battery module 210.

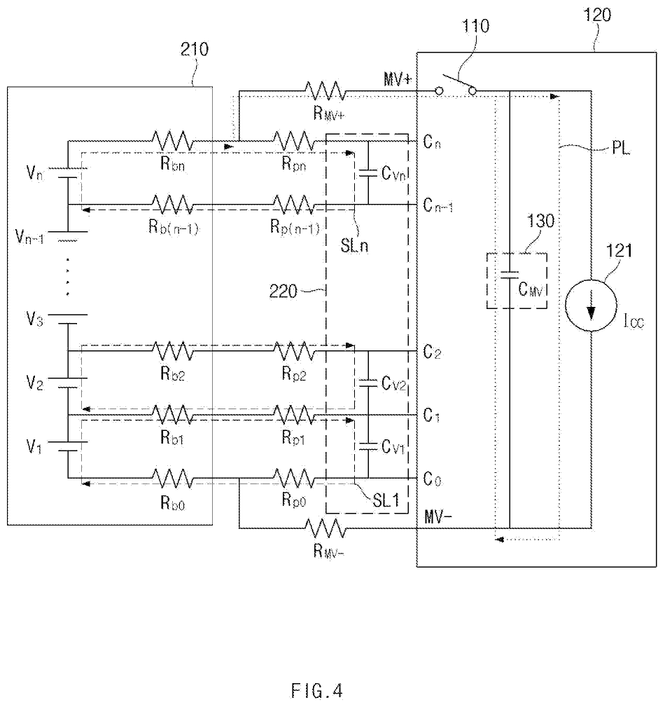

FIG. 4 is a view of a battery management apparatus according to another embodiment disclosed herein.

Referring to FIG. 4, the battery management apparatus 100 according to an embodiment disclosed herein may internalize the switching unit 110 in the controller 120. In this case, the switching unit 110 is included in the controller 120, such that it is not necessary to transmit an additional switch control signal to the outside of the controller 120, and thus the controller 120 may have a function that is substantially the same as the battery management apparatus 100 without changing an external circuit of the controller 120.

Meanwhile, a basic control operation of the battery management apparatus 100 shown in FIG. 4 is substantially the same as that of the battery management apparatus 100 of FIG. 3, and thus a detailed description thereof will be omitted.

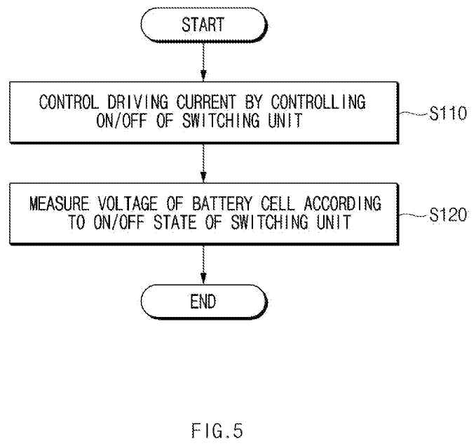

FIG. 5 is a flowchart illustrating a control method of a battery management apparatus according to an embodiment disclosed herein.

The control method of the battery management apparatus 100 according to an embodiment disclosed herein in FIG. 5 may be a method of controlling a battery management apparatus including the switching unit 110 provided to control a driving current applied from a battery module and the controller 120 for controlling the driving current by controlling on/off of the switching unit 110. Herein, the driving current may be a current for driving the controller 120. Moreover, the switching unit 110 may include at least one switch, and may be provided at one end of the battery module. For example, the switching unit 110 may be provided outside or inside the controller 120.

Referring to FIG. 5, the battery management apparatus 100 according to an embodiment disclosed herein may control the driving current by controlling on/off of the switching unit 110, in operation S110. The voltage of the battery cell may be measured according to an on/off state of the switching unit 110, in operation S120.

More specifically, in the control method of the battery management apparatus 100 according to an embodiment disclosed herein, when the voltage of the battery cell is measured through the controller 120, the controller 120 may turn off the switching unit 110 such that the driving current does not flow to the internal resistor of the battery module. For example, the internal resistor of the battery module may be an internal resistor of battery cells provided at opposite ends among a plurality of battery cells included in the battery module.

When the voltage of the battery cell is measured in operation S120, the controller 120 may generate a control signal for turning off the switching unit 110. The generated control signal may be transferred to the switching unit 110 to control an operation of the switching unit 110.

Although not shown in FIG. 5, the control method of the battery management apparatus 100 according to an embodiment disclosed herein may further include an operation of supplying the driving current to the controller 120 through the power supply unit 130. For example, when the switching unit 110 is turned off by the controller 120, the power supply unit 130 may supply previously stored power to the controller 120. In this case, the power supply unit 130 may include a capacitor that may be charged by being supplied with power from the battery module when the switching unit 110 is in an on state.

That is, when the switching unit 110 is in the on state, the power supply unit 130 may be charged with power being supplied from the battery module, and when the switching unit 110 is turned off, the power supply unit 130 may supply, to the controller 120, the charged power that serves as the driving current.

As such, a battery management method according to an embodiment disclosed herein may increase accuracy and improve reliability in measuring a voltage of a battery cell by temporally separating a sensing line and a driving current line, which are shared for a battery module, from each other.

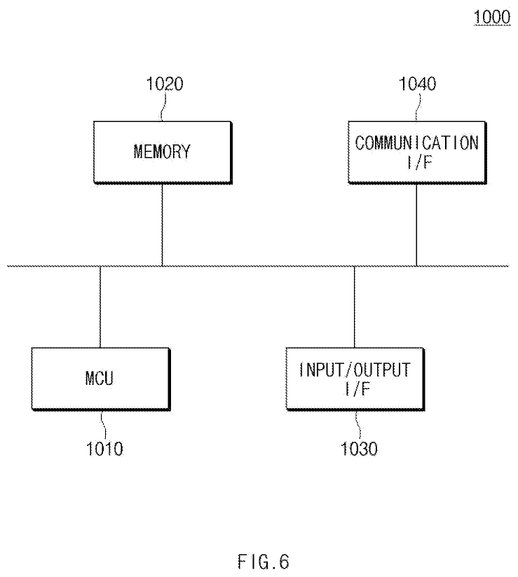

FIG. 6 is a block diagram showing a hardware configuration of a computing system for performing a control method of a battery management apparatus, according to an embodiment disclosed herein.

Referring to FIG. 6, a computing system 1000 according to an embodiment disclosed herein may include a microcontroller unit (MCU) 1010, a memory 1020, an input/output interface (I/F) 1030, and a communication OF 1040.

The MCU 1010 may be a processor that executes various programs (e.g., a battery cell voltage measurement program, a switching control program, etc.) stored in the memory 1020, processes various data including voltage, internal resistance, etc., of a battery cell through these programs, and performs the above-described functions of the battery management apparatus 100 shown in FIG. 1.

The memory 1020 may store various programs regarding voltage measurement, switching control, etc., of the battery cell. Moreover, the memory 1020 may store various data such as a voltage, an internal resistance, etc., of the battery cell.

The memory 1020 may be provided in plural, depending on a need. The memory 1020 may be volatile memory or non-volatile memory. For the memory 1020 as the volatile memory, random access memory (RAM), dynamic RAM (DRAM), static RAM (SRAM), etc., may be used. For the memory 1020 as the nonvolatile memory, read only memory (ROM), programmable ROM (PROM), electrically alterable ROM (EAROM), erasable PROM (EPROM), electrically erasable PROM (EEPROM), flash memory, etc., may be used. The above-listed examples of the memory 1020 are merely examples and are not limited thereto.

The input/output OF 1030 may provide an interface for transmitting and receiving data by connecting an input device (not shown) such as a keyboard, a mouse, a touch panel, etc., and an output device such as a display (not shown), etc., to the MCU 1010.

The communication OF 1040, which is a component capable of transmitting and receiving various data to and from a server, may be various devices capable of supporting wired or wireless communication. For example, a program for voltage measurement and switching control for a battery cell, various data, etc., may be transmitted and received to and from a separately provided external server through the communication OF 1040.

As such, a computer program according to an embodiment disclosed herein may be recorded in the memory 1020 and processed by the MCU 1010, thus being implemented as a module that performs functions shown in FIG. 1.

Even though all components constituting an embodiment disclosed herein have been described above as being combined into one or operating in combination, the embodiments disclosed herein are not necessarily limited to the embodiments. That is, within the object scope of the embodiments disclosed herein, all the components may operate by being selectively combined into one or more.

Moreover, terms such as “include”, “constitute” or “have” described above may mean that the corresponding component may be inherent unless otherwise stated, and thus should be construed as further including other components rather than excluding other components. All terms including technical or scientific terms have the same meanings as those generally understood by those of ordinary skill in the art to which the embodiments disclosed herein pertain, unless defined otherwise. The terms used generally like terms defined in dictionaries should be interpreted as having meanings that are the same as the contextual meanings of the relevant technology and should not be interpreted as having ideal or excessively formal meanings unless they are clearly defined in the present document.

The above description is merely illustrative of the technical idea of the present disclosure, and various modifications and variations will be possible without departing from the essential characteristics of embodiments of the present disclosure by those of ordinary skill in the art to which the embodiments disclosed herein pertains. Therefore, the embodiments disclosed herein are intended for description rather than limitation of the technical spirit of the embodiments disclosed herein and the scope of the technical spirit of the present disclosure is not limited by these embodiments disclosed herein. The protection scope of the technical spirit disclosed herein should be interpreted by the following claims, and all technical spirits within the same range should be understood to be included in the range of the present document.

1. A battery management apparatus comprising:
a controller; and
a switch configured to control electrical connection between a battery module and the controller,
wherein the controller is configured to:
measure a voltage of a battery cell included in the battery module; and
control a driving current transferred from the battery module by controlling the switch based on the measured voltage.

2. The battery management apparatus of claim 1, wherein when the switch is turned on, the battery module and the controller are electrically connected to each other such that the driving current is transferred to the controller through an internal resistor of the battery module.

3. The battery management apparatus of claim 1, wherein the controller is further configured to turn off the switch during measurement of the voltage.

4. The battery management apparatus of claim 1, wherein the battery module comprises a plurality of battery cells, and wherein each battery cell includes a respective internal resistor provided at opposite ends of the battery cell.

5. The battery management apparatus of claim 1, wherein the controller is further configured to generate a control signal to turn off the switch during measurement of the voltage.

6. The battery management apparatus of claim 1, wherein the switch is contained within the controller.

7. The battery management apparatus of claim 1, wherein the driving current is transferred from the battery module to the controller.

8. The battery management apparatus of claim 1, further comprising a power supply configured to supply a power supply driving current to the controller.

9. The battery management apparatus of claim 8, wherein the power supply is further configured to supply stored power to the controller while the switch is off.

10. The battery management apparatus of claim 8, wherein the power supply comprises at least one capacitor.

11. The battery management apparatus of claim 10, wherein the capacitor of the power supply is configured to be charged with power from the battery module while the switch is on.

12. A battery system comprising:
a battery module comprising a plurality of battery cells;
an electricity storage unit connected to the battery module to store a corresponding voltage of each battery cell;
a controller; and
a switch positioned between the battery module and a controller and configured to control electrical connection between the battery module and the controller,
wherein the controller is configured to:
for each battery cell, measure a voltage of the battery cell based on the corresponding voltage stored in the electricity storage unit; and
control a driving current transferred from the battery module by controlling the switch based on the measured voltage.

13. The battery system of claim 12, wherein the electricity storage unit comprises a plurality of capacitors, each capacitor corresponding to a respective battery cell.

14. The battery system of claim 12, wherein while the switch is turned on, the battery module and the controller are electrically connected to each other such that the driving current is transferred to the controller through an internal resistor of the battery module.

15. The battery system of claim 12, wherein the controller is further configured to turn off the switch during measurement of the voltage.

16. The battery system of claim 12, further comprising a power supply connected to the controller and configured to supply a power supply driving current to the controller.

17. The battery system of claim 16, wherein the power supply is further configured to supply stored power to the controller while the switch is off.

18. The battery system of claim 16, wherein the power supply unit comprises at least one capacitor.
